(19) United States
(12) Patent Application Publication
(10) Pub. No.: US 2016/0311203 A1
(43) Pub. Date: Oct. 27, 2016

(54) POLYMER MIXTURE FOR BARRIER FILM

(71) Applicant: BASF SE, Ludwigshafen (DE)

(72) Inventors: Motonori YAMAMOTO, Mannheim (DE); Siomon A. GRUENER, Altdorf (DE); Maximilian LEHENMEIER, Heidelberg (DE)

(73) Assignee: BASF SE, Ludwigshafen (DE)

(21) Appl. No.: 15/102,696

(22) PCT Filed: Dec. 5, 2014
(86) PCT No.: PCT/EP2014/076760

§ 371 Date: Jun. 8, 2016

(30) Foreign Application Priority Data
Dec. 10, 2013 (EP) 13196444.7

(51) Int. Cl. B32B 27/08; B32B 27/36; B32B 27/20; C08L 67/04; C08J 5/18

(52) U.S. Cl. CPC B32B 27/08; C08L 67/04; C08J 5/18; B32B 27/20; B32B 27/36; B32B 27/365; C08J 2367/04; C08J 2467/02; B32B 2264/104; B32B 2307/7163; B32B 2439/70; B32B 2250/40

(57) ABSTRACT

The present invention relates to a biodegradable polymer mixture comprising:
i) from 55 to 90% by weight, based on components i and ii, of a polyglycolic acid (PGA) and
ii) from 10 to 45% by weight, based on components i and ii, of at least one bio-degradable polyester formed from aliphatic or from aliphatic and aromatic di-carboxylic acids and from aliphatic diols.

The invention further relates to single-or multilayer foils comprising these polymer mixtures, and to the use of the foils for food-or-drink packaging.

The present invention relates to a biodegradable polymer mixture comprising:
i) from 55 to 90% by weight, based on components i and ii, of a polyglycolic acid (PGA) and
ii) from 10 to 45% by weight, based on components i and ii, of at least one biodegradable polyester formed from aliphatic or from aliphatic and aromatic dicarboxylic acids and from aliphatic diols,

The invention further relates to single- or multilayer foils comprising these polymer mixtures, and to the use of the foils for food-or-drink packaging.

JP 2012040688 discloses laminated multilayer foils which have an external layer made of polylactic acid, an adhesion layer made of an aliphatic-aromatic polyester, and a layer made of polyglycolic acid. These foils have interesting gas-barrier properties, but are not always entirely satisfactory in terms of their mechanical properties. Single-layer foils made of polyglycolic acid fail by way of example to meet the hydrolysis-resistance requirements placed upon packaging foils.

It was accordingly an object of the present invention to provide polymer mixtures which can be processed by extrusion or coextrusion to give foils with good barrier properties and improved mechanical properties.

Surprisingly, this is achieved via the polymer mixtures of the invention comprising:
i) from 55 to 90% by weight, based on components i and ii, of a polyglycolic acid (PGA) and
ii) from 10 to 45% by weight, based on components i and ii, of a biodegradable polyester formed from aliphatic or from aliphatic and aromatic dicarboxylic acids and from aliphatic diones.

These give good results in processing by extrusion or coextrusion to give foils with very good barrier properties, in particular with a high barrier to water vapor and to oxygen. These films moreover have improved mechanical properties.

The invention is described in more detail below.

The expression polyglycolic acid means either homopolymers of glycolide or of glycolic acid or copolyesters which comprise, alongside glycolide or glycolic acid, up to 30% of comonomer, for example lactic acid, lactide, ethylene oxalate, or c-caprolactone, These polyesters and copolyesters are covered by the above definition irrespective of whether the monomers used take the form of lactones or take the form of aliphatic hydroxycarboxylic acids. The expression polyglycolic acid moreover covers branched and linear polyesters, preference being given here to linear polyesters. In particular, the expression polyglycolic acid means products such as Kuredux® (Kureha).

Copolymers mentioned by way of example are: ethylene oxalate, lactide, lactic acid, β-propiolactone, β-butyrolactone, pivalolactone, γ-butyrolactone, δ-valerolactone, ε-caprolactone, trimethylene carbonate, 1,3-dioxane, dioxanone, c-caprolactam, 3-hydroxypropionoic acid, 4-hydroxybutanoic acid, and 6-hydroxyhexanoic acid. The hydroxycarboxylic acids or ester-forming derivatives thereof here can be used individually or in the form of a mixture of two or more thereof.

The polyglycolic acids generally have a number-average molar mass (Mn) in the range from 5000 to 500 000 g/mol, in particular in the range from 10 000 to 250 000 g/mol, preferably in the range from 15 000 to 100 000 g/mol, a weight-average molar mass (Mw) of from 30 000 to 1 000 000 g/mol, preferably from 60 000 to 500 000 g/mol, and an Mw/Mn ratio of from 1 to 6, preferably from 1 to 4, The melting point is in the range from 200 to 250° C., preferably in the range from 210 to 240° C.

The MVR (melt volume rate) of the polyglycolic acid in accordance with EN ISO 1133 (240° C., 2.16 kg weight) is generally from 0.1 to 70 cm³/10 min, preferably from 0.8 to 70 cm³/10 min, and in particular from 1 to 60 cm³/10 min.

A suitable component ii for the polymer mixtures of the invention comprises biodegradable polyesters based on aliphatic or on aliphatic and aromatic dicarboxylic acids and on aliphatic dihydroxy compounds. The latter are also termed semiaromatic polyesters. A feature shared by these polyesters is that they are biodegradable in accordance with DIN EN 13432. Mixtures of a plurality of these polyesters are, of course, also suitable.

The expression semiaromatic (aliphatic-aromatic) polyesters is also intended in the invention to cover polyester derivatives which comprise up to 10 mol % of functions other than ester functions, examples being polyetheresters, polyesteramides or polyetheresteramides, and polyesterurethanes. Among the suitable semiaromatic polyesters are linear non-chain-extended polyesters (WO 92/09654). Preference is given to chain-extended and/or branched semiaromatic polyesters. The latter are known from the following documents cited in the introduction: WO 96/15173 to 15176, 21689 to 21692, 25446, 25448, or WO 98/12242, expressly incorporated herein by way of reference. Mixtures of various semiaromatic polyesters can equally be used. Interesting relatively recent developments are based on renewable raw materials (see WO-A 2006/097353, WO-A 2006/097354, and WO2010/034689). The expression semiaromatic polyesters in particular means products such as ecoflex® (BASF SE) and Eastar® Bio and Origo-Bi® (Novamont).

Among the preferred aliphatic and particularly preferred semiaromatic polyesters are polyesters comprising as substantial components:
A1) from 30 to 100 mol %, preferably from 30 to 70 mol %, and with particular preference from 40 to 60 mol %, based on components A1) to A2), of an aliphatic dicarboxylic acid or a mixture thereof, preferably as follows: succinic acid, azelaic acid, sebacic acid, and brassylic acid,
A2) from 0 to 70 mol %, preferably from 30 to 70 mol %, and with particular preference from 40 to 60 mol %, based on components A1) to A2), of an aromatic dicarboxylic acid or a mixture thereof, preferably as follows: terephthalic acid,
B) from 98.5 to 100 mol %, based on components A1) to A2), of a diol component made of a C₂-C₁₂-alkanediol or a mixture thereof, preferably as follows: 1,4-butanediol and 1,3- propanediol; and
C) from 0.05 to 1.5% by weight, based on components A1) to A2) and B, of one compound or of a plurality of compounds selected from the group consisting of:
   C1) a compound having at least three groups capable of ester formation, preferably as follows: trimethylolpropane, pentaerythritol, and in particular glycerol,
   C 2) a di- or polyfunctional isocyanate, preferably hexamethylene diisocyanate,
   C3) a di- or polyfunctional epoxide.

Aliphatic acids and the corresponding derivatives A1 that can be used are generally those having from 2 to 18 carbon atoms, preferably from 4 to 10 carbon atoms. They can be either linear or branched. It is also in principle possible, however, to use dicarboxylic acids having a larger number of carbon atoms, for example having up to 30 carbon atoms.

Mention may be made by way of example of: oxalic acid, maionic acid, succinic acid, giutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxaloacetic acid, glutamic acid, aspartic acid, itaconic acid, and maleic acid. It is possible here to use the dicarboxylic acids, or ester-forming derivatives thereof, individually or in the form of mixture of two or more thereof.

Preference is given to use of succinic acid, adipic acid, azelaic acid, sebacic acid, brassylic acid, or respective ester-forming derivatives thereof, or a mixture thereof. Particular preference is given to use of succinic acid, adipic acid, or sebacic acid, or respective ester-forming derivatives thereof, or a mixture thereof. An additional advantage of succinic acid, azelaic acid, sebacic acid, and brassylic acid is that they are obtainable from renewable raw materials.

Preference is in particular given to the following aliphatic-aromatic polyesters: polybutylene adipate terephthalate (PBAT), polybutylene sebacate terephthaiate (PBSeT), or polybutylene succinate terephthalate (PBST), and very particular preference is given to polybutylene adipate terephthalate (PBAT) and to polybutylene sebacate terephthalate (PBSeT).

The aromatic dicarboxylic acids or ester-forming derivatives thereof A2 can be used individually or in the form of mixture of two or more thereof. It is particularly preferable to use terephthalic acid or ester-forming derivatives thereof, for example dimethyl terephthalate.

The diols B are generally selected among branched or linear alkanediols having from 2 to 12 carbon atoms, preferably from 4 to 6 carbon atoms, or among cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propanediol, 1,4-butanediol, and 2,2-dimethyl-1,3-propanediol (neopentyl glycol). Particular preference is given to 1,4-butanediol and 1,3-propanediol. An additional advantage of the latter is that they are obtainable in the form of a renewable raw material. It is also possible to use a mixture of various alkanediols.

Use is generally made of from 0.01 to 2% by weight, preferably from 0.1 to 1.0% by weight, and in with particular preference from 0.1 to 0.3% by weight, based on the total weight of the polyester, of a branching agent (C1) and/or from 0.1 to 1.0% by weight, based on the total weight of the polyester, of a chain extender (C2 or C3). The branching agent is preferably selected from the group consisting of: a polyfunctional isocyanate, isocyanurate, oxazoline, epoxide, peroxide, carboxylic anhydride, an at least trihydric alcohol, and an at least tribasic carboxylic acid. Particular chain extenders that can be used are difunctional isocyanates, isocyanurates, oxazolines, or a carboxylic anhydride, or epoxides.

Particularly preferred branching agents have from three to six functional groups. Mention may be made by way of example of: tartaric acid, citric acid, malic acid; trimethylolpropane, trimethylolethane; pentaerythritol; polyethertriols and glycerol, trimesic acid, trimellitic acid, trimellitic anhydride, pyromellitic acid, and pyromellitic dianhydride. Preference is given to polyols such as trimethylolpropane, pentaetythritol, and in particular glycerol. By using component C it is possible to construct biodegradable polyesters which have pseudoplasticity. The biodegradable polyesters have relatively good processability.

For the purposes of the present invention, the term diisocyanate means especially linear or branched alkylene diisocyanates or cycloalkylene diisocyanates having from 2 to 20 carbon atoms, preferably from 3 to 12 carbon atoms, an example being hexamethylene 1,6-diisocyanate, isophorone diisocyanate, or methylenebis(4-isocyanatocyclo-hexane). Particularly preferred aliphatic diisocyanates are isophorone diisocyanate and in particular hexamethylene 1,6-diisocyanate.

The expression polyfunctional epoxides in particular means a copolymer based on styrene, acrylate and/or methacrylate and comprising epoxy groups. The units bearing epoxy groups are preferably glycidyl (meth)acrylates. Copolymers having more than 20% by weight glycidyl methacrylate content, particularly preferably more than 30% by weight, and with particular preference more than 50% by weight based on the copolymer, have proven advantageous. The epoxy equivalent weight (EEW) in these polymers is preferably from 150 to 3000 g/equivalent and with particular preference from 200 to 500 g/equivalent. The average molecular weight (weight average) M_{w} of the polymers is preferably from 2000 to 25 000, in particular from 3000 to 8000. The average molecular weight (number average) Mₙ of the polymers is preferably from 400 to 6000, in particular from 1000 to 4000. The polydispersity (Q) is generally from 1.5 to 5. Copolymers of the abovementioned type comprising epoxy groups are marketed by way of example with trademark Joncryl® ADR by BASF Resins B.V. An example of a particularly suitable chain extender is Joncryl® ADR 4368.

It is generally sensible to add the crosslinking (at least trifunctional) compounds at a relatively early juncture during the polymerization reaction.

The polyesters generally have a number-average molar mass (Mn) in the range from 5000 to 100 000 g/mol, in particular in the range from 10 000 to 75 000 g/mol, preferably in the range from 15 000 to 38 000 g/mol, a weight-average molar mass (Mw) of from 30 000 to 300 000 g/mol, preferably from 60 000 to 200 000 girnol, and an Mw/Mn ratio of from 1 to 6, preferably from 2 to 4. Intrinsic viscosity is from 50 to 450 g/L, preferably from 80 to 250 g/L (measured in o-dichlorobenzene/phenol (ratio by weight 50/50). The melting point is generally in the range from 85 to 150° C., preferably in the range from 95 to 140° C.

The preferred semiaromatic polyesters are characterized by a molar mass (Mn) in the range from 1000 to 100 000 g/mol, in particular in the range from 9000 to 75 000 g/mol, preferably in the range from 10 000 to 50 000 g/mol, coupled with a melting point in the range from 60 to 170° C., preferably in the range from 80 to 150° C.

The expression aliphatic polyesters means polyesters made of aliphatic diols and of aliphatic dicarboxylic acids, for example polybutylene succinate (PBS), polybutylene adipate (PBA), polybutylene succinate adipate (PBSA), polybutylene succinate sebacate (PBSSe), polybutylene sebacate (PBSe), or corresponding polyesteramides or polyesterurethanes. The aliphatic polyesters are marketed by way of example by Showa Highpolymers as Bionolle and by Mitsubishi as GSPIa. Relatively recent developments are described in WO2010034711. Preferred aliphatic polyesters are polybutylene succinate sebacate (PBSSe) and in particular polybutylene sebacate (PBSe).

The intrinsic viscosities of the aliphatic polyesters in accordance with DIN 53728 are generally from 150 to 320 cm³/g and preferably from 150 to 250 cm³/g.

The MVR (melt volume rate) in accordance with EN ISO 1133 (190° C., 2.16 kg weight) is generally from 0.1 to 70 cm³/10 min, preferably from 0.8 to 70 cm³/10 min, and in particular from 1 to 60 cm³/10 min.

The acid numbers in accordance with DIN EN 12634 are generally from 0.01 to 1.2 mg KOH/g, preferably from 0.01 to 1.0 mg KOH/g, and with particular preference from 0.01 to 0.7 mg KOH/g.

The polyesters can also comprise mixtures of aliphatic-aromatic polyesters and of purely aliphatic polyesters, for example mixtures of PBAT and PBS.

Polyesters having the following composition are particularly useful as component ii:
from 40 to 100 mol %, based on the total amount of dicarboxylic acid, of at least one aliphatic C₄-C₁₈-dicarboxylic acid or C₄-C₁₈-dicarboxylic acid derivative;
from 0 to 60 mol %, based on the total amount of dicarboxylic acid, of terephthalic acid or terephthalic acid derivative, and
100 mol %, based on the total amount of dicarboxylic acid, of 1,4-butanediol or 1,3-propanediol.

The polymer mixtures of the invention can comprise other additional substances,

In one preferred embodiment, from 0.01 to 3.0% by weight, based on components i and ii, of a natural wax is added to the polymer mixture of the invention, preferably from 0.05 to 2.0% by weight, and with particular preference from 0.1 to 0.5% by weight. It is thus possible to achieve a further marked improvement in the water-vapor barrier of the barrier foils (single- or multilayer foil comprising this polymer mixture). If amounts of natural wax used are higher, the barrier effect declines again.

The expression natural wax means animal and vegetable waxes such as beeswax, carnauba wax, candelilla wax, Japan wax, esparto grass wax, cork wax, guaruma wax, rice germ oil wax, sugar cane wax, ouricury wax, schellac wax, spermaceti, lanolin (wool wax), uropygial grease, sasol waxes, jojoba waxes, or else montan wax, which can be obtained from lignite and is therefore likewise of vegetable origin. Preference is given to carnauba wax, candelilla wax, montan wax, and in particular beeswax.

It is moreover possible to add, to the polymer mixture, from 0.5 to 50% by weight, based on components i and ii, of a filler selected from the group consisting of calcium carbonate, talc, kaolin, clay, mica, and thermoplastified or non-thermoplastified starch. Addition of the particularly preferred inorganic fillers calcium carbonate, talc, kaolin, clay, mica can achieve a further improvement in the water-vapor barrier of the polymer mixtures. Total amounts of fillers added to the polyester mixtures can by way of example be from 5 to 35% by weight, based on the total weight of the polymer mixture.

Amounts used of calcium carbonate can by way of example be from 5 to 25% by weight, preferably from 10 to 20% by weight, based on the total weight of the polymer mixture. Calcium carbonate from Omya has proven inter alia to be suitable. The average particle size of the calcium carbonate is generally from 0.5 to 10 micrometers, preferably from 1 to 5 micrometers, particularly preferably from 1 to 2.5 micrometers.

Amounts used of talc can by way of example be from 3 to 15% by weight, preferably from 5 to 10% by weight, based on the total weight of the polymer mixture. Talc from Mondo Minerals has proven inter alia to be suitable. The average particle size of the talc is generally from 0.5 to 10 micrometers, preferably from 1 to 8 micrometers, particularly preferably from 1 to 3 micrometers.

Addition of thermoplastified or non-thermoplastified starch, or else of calcium carbonate and talc, can achieve a further improvement in the tear-propagation resistance of the foils. The term starch also covers amylose; the term thermoplastified means surface-modified (see EP-A 539 541, EP-A 575 349, EP-A 652 910) or thermoplastified (see EP-A 937120, EP-A 947559, EP-A 965615) with plasticizers such as glycerol, sorbitol, or water. The polymer mixtures of the invention which comprise from 10 to 35% by weight, based on the total weight of the polymer mixture, of thermoplastic or non-thermoplastic starch have not only good degradability in soil but also good mechanical properties, a particular example being high tear-propagation resistance. These mixtures comprising starch are therefore an interesting alternative to the abovementioned mixtures comprising filler (comprising calcium carbonate and/or talc), optionally also in combination with the polymer mixtures comprising filler.

The polyester mixture can accordingly also comprise further ingredients. The expression polymer mixture is used below for the polyester mixture inclusive of all further ingredients.

The polyester foil of the invention can moreover comprise further additives known to the person skilled in the art. Examples are the additional substances conventionally used in plastics technology, e.g. stabilizers; nucleating agents; lubricants and release agents such as stearates (in particular calcium stearate); plasticizers such as citric esters (tributyl acetylcitrate), glycerol esters such as triacetylglycerol, or ethylene glycol derivatives, surfactants such as polysorbates, palmitates, or laurates: waxes such as erucamide, stearamide, or behenamide, beeswax, or beeswax esters; antistatic agents, UV absorbers; UV stabilizers; antifogging agents, or dyes. The concentrations used of the additives are usually from 0 to 2% by weight, in particular form 0.1 to 2% by weight, based on the polyester foil of the invention. The polyester foil of the invention can comprise from 0.1 to 10% by weight of plasticizers.

Single-layer foils of thickness from 5 to 100 pm using the polyester mixture of the invention exhibit water vapor transmission rates of from 1.0 to 30 g 100 μm/m²d and preferably from 2.0 to 10 g 100 μm/m²d, measured in accordance with ASTM F1249 (of Aug. 1, 2011; 23° C., 85% relative humidity).

In one preferred embodiment, the single-layer foils can also comprise, alongside the polyester mixtures of the invention, further polymers selected from the group consisting of: polylactic acid (PLA), polycaprolactone (PCL), and polyhydroxyalkanoate.

Preference is given to multilayer foils, where the middle layer represents a barrier foil and comprises a polymer mixture of the invention according to any of claims 1 to 4.

The multilayer foil can have either symmetrical or asymmetrical structure, but the expression barrier foil does not cover any outermost layer. The layer thicknesses of the individual constituents are generally from 0.01 to 100 pm, but preferably from 0.1 to 50 pm. There is no restriction on the number of repeating layers.

Particular preference is given to a biodegradable multilayer foil comprising the layer sequence (A)(B) or (B)(A)(B), in which the composition of the layers A and B is as follows:

A) layer A comprises a polymer mixture of the following composition:
ai) from 55 to 90% by weight, based on the total weight of components ai and aii, of a polyglycolic acid (PGA) and
aii) from 10 to 45% by weight, based on the total weight of components ai and aii, of at least one biodegradable polyester formed from aliphatic or from aliphatic and aromatic dicarboxylic acids and from aliphatic diols

B) layer B comprises:
bi) from 0 to 70% by weight, preferably from 5 to 50% by weight, based on the total weight of components bi and bii, of at least one polymer selected from the group consisting of polylactic acid, polyhydroxyalkanoate, and polypropylene carbonate, and
bii) from 30 to 100% by weight, preferably from 5 to 50% by weight, based on the total weight of the components bi and bii, of at least one biodegradable polymer formed from aliphatic or from aliphatic and aromatic dicarboxylic acids and from aliphatic diones.

The multilayer foils can moreover also comprise, in the further layers, alongside the polymer mixture of the invention, polymers selected from the group consisting of: polylactic acid (PLA), polycaprolactone (PCL), and polyhydroxyalkanoate, thermoplastified and non-thermoplastified starch, or polyester produced from aliphatic and aliphatic or aromatic dicarboxylic acids and from an aliphatic dihydroxy compound.

It is preferable to use PLA with the following property profile:
a melt volume rate (MVR) of from 0.5 to 30 cm³/10 min, in particular from 2 to 40 cm³/10 min, in accordance with EN ISO 1133 (190° C., 2.16 kg weight)
a melting point below 240° C.;
a glass transition temperature (Tg) above 55° C.
water content below 1000 ppm
residual monomer content (lactide) below 0.3%
molecular weight above 80 000 daltons.

Examples of preferred polylactic acids are Ingeo® 8052D, 6201D, 6202D, 6251D, 3051D, and in particular Ingeo® 4020D, 4032D, or 4043D (polylactic acid from NatureWorks).

Addition of PLA in the claimed range of amounts can achieve a further marked improvement in the properties of the polyester foil (puncture resistance and tear-propagation resistance) produced from the polymer mixture. It is also possible to use mixtures of free-flowing and higher-viscosity PLA.

The term polyhydroxyalkanoates primarily means poly-4-hydroxybutyrates and poly-3-hydroxybutyrates, and copolyesters of the abovementioned polyhydroxybutyrates with 3-hydroxyvalerate, 3-hydroxyhexanoate, and/or 3-hydroxyoctanoate. Poly-3-hydroxybutyrates are by way of example marketed by PHB Industrial with trademark Biocycle® and by Tianan with trademark Enmat®.

Poly-3-hydroxybutyrate-co-4-hydroxybutyrates are in particular known from Metabolix. They are marketed with trademark Mirel®.

Poly-3-hydroxybutyrate-co-3-hydroxyhexanoates are known from P&G or Kaneka.

The proportion of 3-hydroxyhexanoate in poly-3-hydroxybutyrate-co-3-hydroxyhexanoates is generally from 1 to 20% by weight and preferably from 3 to 15 mol %, based on the polyhydroxyalkanoate. The molecular weight Mw of the polyhydroxyhexanoates is generally from 100 000 to 1 000 000 and preferably from 300 000 to 600 000.

The polypropylene carbonate can be produced by way of example by analogy with WO 2003/029325, WO 2006/061237, or WO 2007/127039.

Polyesters bii used can be the same as the aliphatic or aliphatic-aromatic polyesters aii described above, but it is also possible to use different polyesters aii and bii.

It is also possible to add to the polymer mixtures, in particular to the mixtures comprising polylactic acid, from 0 to 1% by weight, preferably from 0.01 to 0.8% by weight, particularly preferably from 0.05 to 0.5% by weight, based on the total weight of components i to ii, of copolymer based on styrene, acrylate, and/or acrylate and comprising epoxy groups. The units bearing epoxy groups are preferably glycidyl (meth)acrylates. A particularly suitable material is Joncryl® ADR 4368, already described above.

The single- or multilayer foils of the invention can be produced by using the conventional production processes such as lamination processes or extrusion processes, as described by way of example in J. Nentwig “Kunststoff-Folien” [Plastics foils], 2^{nd} edn., Hanser Verlag, Munich (2006), pp. 39 to 63. For the multilayer foils, a particularly suitable production process has proven to be coextrusion as described by way of example in J. Nentwig “Kunststoff-Folien” [Plastics foils], 2^{nd} edn., Hanser Verlag, Munich (2006), pp. 58 to 60.

These foils can be used inter alia for food-or-drink packaging, in order to ensure longer shelf life for said products. Mention may be made here by way of example of meat packaging, fish packaging, cheese packaging, chocolate packaging, and also of packaging for coffee, tea, and spices. The foils here can by way of example be used in the form of overwrap or in the form of lid foil.

The water-vapor barrier was measured in accordance with the updated version of ASTM F-1249 of Aug. 1, 2011.

Component i:

i-1: Kuredux® 100E35 from Kureha: polyglycolic acid.

Component ii:

ii-1: ecoflex® C1201 from BASF SE: polybutyleneterephthalate-co-adipate.

Component iii:

iii-1: Aonilex® ADR 4368 CS from Kaneka: poly-3-hydroxybutyrate-co-hexanoate.

I. Compounding of Polymer Mixture

### GENERAL SPECIFICATION (EXAMPLE 1)

The compounding was carried out in an extruder of 250° C. Mixtures were produced from components i-1 and ii-2. In order to ensure good mixing of the components, the material was mixed for three minutes at a rotation rate of 80 revolutions/minute. After this time, the melt was discharged and the strand was processed to give relatively small pieces.

### COMPARATIVE EXAMPLE 1a

Here, 100% by weight of component i-1 was used as described in example 1.

### INVENTIVE EXAMPLE 1b

Here, 80% by weight of component i-1 and 20% by weight of component ii-1 were used as described in example 1.

### INVENTIVE EXAMPLE 1c

Here, 60% by weight of component i-1 and 40% by weight of component ii-1 were used as described in example 1.

### COMPARATIVE EXAMPLE 1d

Here, 50% by weight of component i-1 and 50% by weight of component were used as described in example 1.

### COMPARATIVE EXAMPLE 1e

Here, 40% by weight of component i-1 and 60% by weight of component ii-1 were used as described in example 1.

### COMPARATIVE EXAMPLE 1f

Here, 20% by weight of component i-1 and 80% by weight of component ii-1 were used as described in example 1.

### COMPARATIVE EXAMPLE 1g

Here, 100% by weight of component ii-1 was used as described in example 1.

### GENERAL SPECIFICATION (COMPARATIVE EXAMPLE 2)

The compounding was carried out in an extruder at a temperature of 170° C. Mixtures were produced from components iii-1 and ii-2. In order to ensure good mixing of the components, the material was mixed for three minutes at a rotation rate of 80 revolutions/minute. After this time, the melt was discharged and the strand was processed to give relatively small pieces.

### COMPARATIVE EXAMPLE 2a

Here, 100% by weight of component ii-1 was used as described in example 1.

### COMPARATIVE EXAMPLE 2b

Here, 80% by weight of component ii-1 and 20% by weight of component ii-1 were used as described in example 1.

### COMPARATIVE EXAMPLE 2c

Here, 60% by weight of component ii-1 and 40% by weight of component ii-1 were used as described in example 1.

### COMPARATIVE EXAMPLE 2d

Here, 50% by weight of component ii-1 and 50% by weight of component ii-1 were used as described in example 1.

### COMPARATIVE EXAMPLE 2e

Here, 40% by weight of component ii-1 and 60% by weight of component ii-1 were used as described in example 1.

### COMPARATIVE EXAMPLE 2f

Here, 20% by weight of component ii-1 and 80% by weight of component ii-1 were used as described in example 1.

### COMPARATIVE EXAMPLE 2g

Here, 100% by weight of component ii-1 was used as described in example 1.

II. Production of Pressed Foils

Polyester mixtures from examples 1 and 2 were pressed in an Hy 1086 heated press from IWK to give pressed foils (100 μm). Compounding materials with component i-1 were processed at a temperature of 265° C., the corresponding temperature for component iii-1 being 180° C. The press equipment was used as follows. The following were placed in ascending sequence between the press jaws: a steel plate, a Teflon foil, a steel frame, and within this the plastic, a Teflon foil, and finally another steel plate. The granulate was melted for 10 minutes, and then incubated at 50 bar for 1 minute, at 100 bar for 1 minute, and at 200 bar for 2 minutes. The system was cooled under pressure, and the foil was removed from the mold.

III. Determination of Water-Vapor Barrier

Water-vapor transmission was measured in accordance with ASTM F1249 at 23° C. against the gradient from 85% relative humidity in a Permatran 3/33 from Mocon. Thicknesses of material for the calculation of permeability of the test samples were determined in accordance with DIN 53370 by a mechanical method. Permeability is reported in g 100 μm/m²d. In order to achieve maximum comparability with other materials, the value measured was related to a layer thickness of 100 μm. Permeability to oxygen was likewise measured at 23° C., but with 0% relative humidity (O₂ gradient 1 bar). Permeability to oxygen is determined with the units cm³ 100 jn/m²d bar.

IV. Determination of Hydrolysis Resistance

Foil samples were stored at 50° C. and 98% relative humidity in a WK111¹⁸⁰ cabinet from Weiss. At defined time intervals, assessments determined whether the foil remains fully intact or has been hydrolyzed. The time during which the foil remained intact in the cabinet is reported in days.

| | CE-1a | IE-1b | IE-1c | CE-1d | CE-1e | CE-1f | CE-1g |
|---|---|---|---|---|---|---|---|
| Component i-1 | 100 | 80 | 60 | 50 | 40 | 20 | 0 |
| (% by weight) | | | | | | | |
| Component ii-1 | 0 | 20 | 40 | 50 | 60 | 80 | 100 |
| (% by weight) | | | | | | | |
| Compounding | 250 | 250 | 250 | 250 | 250 | 250 | 250 |
| temperature (° C.) | | | | | | | |
| Processing | 265 | 265 | 265 | 265 | 265 | 265 | 265 |
| temperature (° C.) | | | | | | | |
| H₂O_{(g)} permeability | 2.29 | 2.39 | 2.49 | 26.70 | 55.00 | 53.80 | 82.00 |
| (g 100 μm/m²d) | | | | | | | |
| 23° C., 85% r.h. | | | | | | | |
| O₂ permeability | 0.38 | | 1.70 | 286.20 | | | 624.24 |
| (cm³ 100 μm/m²d bar) | | | | | | | |
| 23° C. 0% r.h. | | | | | | | |
| Hydrolysis resistance | 4 | 8 | 8 | | >42 | >42 | >42 |
| | CE-2a | CE-2b | CE-2c | CE-2d | CE-2e | CE-2f | CE-2g |
| Component iii-1 | 100 | 80 | 60 | 50 | 40 | 20 | 0 |
| (% by weight) | | | | | | | |
| Component ii-1 | 0 | 20 | 40 | 50 | 60 | 80 | 100 |
| (% by weight) | | | | | | | |
| Compounding | 170 | 170 | 170 | 170 | 170 | 170 | 170 |
| temperature (° C.) | | | | | | | |
| Processing | 180 | 180 | 180 | 180 | 180 | 180 | 180 |
| temperature (° C.) | | | | | | | |
| H₂O_{(g)} permeability | 4.00 | 12.60 | 19.00 | 20.60 | 30.35 | 43.50 | 82.00 |
| (g 100 μm/m²d) | | | | | | | |
| 23° C., 85% r.h. | | | | | | | |

1.-6. (canceled)

7. A biodegradable polymer mixture comprising:
i) from 55 to 90% by weight, based on components i and ii, of a polyglycolic acid (PGA) and
from 10 to 45% by weight, based on components i and ii, of a biodegradable polyester formed from aliphatic or from aliphatic and aromatic dicarboxylic acids and from aliphatic diols, where component ii has been formed from
from 40 to 100 mol %, based on the total amount of dicarboxylic acid, of at least one aliphatic C₄-C₁₈-dicarboxylic acid or C₄-C₁₈-dicarboxylic acid derivative;
from 0 to 60 mol %, based on the total amount of dicarboxylic acid, of terephthalic acid or terephthalic acid derivative, and
100 mol %, based on the total amount of dicarboxylic acid, of 1,4-butanediol or 1,3-propanediol.

8. The polyester mixture according to claim 7, further comprising from 0.05 to 2.0% by weight, based on components i and ii, of a natural wax.

9. The polyester mixture according to claim 7, further comprising from 0.5 to 50% by weight, based on components i and ii, of a filler selected from the group consisting of calcium carbonate, talc, kaolin, clay and mica.

10. A biodegradable foil comprising the polymer mixture according to claim 7.

11. A biodegradable multilayer foil comprising the layer sequence (A)(B) or (B)(A)(B), in which the composition of the layers A and B is as follows:
A) layer A comprises the polymer mixture according to claim 7;
B) layer B comprises:
bi) from 0 to 70% by weight, based on the total weight of components bi and bii, of at least one polymer selected from the group consisting of polylactic acid, polyhydroxyalkanoate, and polypropylene carbonate, and
bii) from 30 to 100% by weight, based on the total weight of the components bi and bii, of at least one biodegradable polymer formed from aliphatic or from aliphatic and aromatic dicarboxylic acids and from aliphatic diols.

12. A food-or-drink packaging which comprises the foil according to claim 10.
